(19) United States
(12) Patent Application Publication
(10) Pub. No.: US 2016/0047166 A1
(43) Pub. Date: Feb. 18, 2016

(54) P.C. Holster/Tool Holder

(71) Applicant: Thomas Michael Payne, Tappan, NY (US)

(72) Inventor: Thomas Michael Payne, Tappan, NY (US)

(21) Appl. No.: 14/458,246

(22) Filed: Aug. 12, 2014

(51) Int. Cl. E06C 7/14; F16B 1/00; F16M 13/02; A45F 5/02

(52) U.S. Cl. CPC E06C 7/14; A45F 5/021; F16B 1/00; F16M 13/022; F16B 2001/0028

(57) ABSTRACT

The “P C Holster/Tool Holder” is a unique, reusable, multipurpose tool holder which allows small hand tools or a container with a handle, such as “The Paint Can-dle” described in U.S. patent application Ser. No. 14/255,024 filed Apr. 17, 2014, to be removably attached and suspended in an upright, usable position, from the waist belt of a workman or attached to an extended ladder by utilizing selected strap slots provided, freeing up his hands for safer, more convenient handling and storage of said container or tool.

### BACKGROUND OF THE INVENTION

The present invention relates to an improved tool holder which is designed to secure a fluid holding container, having an attached handle, or small hand tools in place upon the users body or when affixed to an extended ladder.

Tool holsters, sheaths, holders or shrouds can be made from leather, cloth, plastic, bent wire or most any material and the first such covering was most likely created shortly after the first tool injured its inventor.

In the past, tool holders have typically been comprised of a container or receptacle with varying means for being carried, secured or attached to varied supports, such as ladders, scaffolding and worker's belts. These tool holders generally fall into five groups, (1) fastened to a wall or other structure, (2) enclosed packets or cases, (3) portable devices which can be worn on a belt about the waist or elsewhere on the users person, (4) carried by hand, and (5) combinations of 1 through 3.

The “PC Holster/Tool Holder” fits the “ (5) combination” category as it is a device created to be worn on a belt about the users waist or be attached to an extended step or extension ladder for safely holding a tool in a useable, somewhat upright position. The said tool, in this case, refers to a handle described in Utility patent application Ser. No. 14/255,024 filed Apr. 17, 2014. This application describes a handle system, designed for the quart size paint can, which has a relatively straight grip portion which can be inserted into the protruding tool holding collar of this new invention. Said collar might alternately hold a paint brush or some other small tools such as hammers, screwdrivers pliers and the like.

This ability to hold a paint can upright while attached to the ladder allows the user to hold said ladder with one hand while painting with the other, safely move the paint can with the ladder or, when worn about the waist, to safely use both hands when climbing or descending said ladder.

When working from a step ladder, a painter will climb up the ladder and place a bucket or can of paint on the top surface or fold out shelf. Once having completed painting the area, the painter climbs down the ladder and moves the ladder to a new location. If he neglects to remove the container before moving the ladder it can fall off, resulting in time spent cleaning instead of painting. When working from the ground, the painter usually places the bucket next to him on the floor or some raised surface. However this placement of the paint bucket requires repeated bending to reapply the paint to the brush. Also the ground of a construction site can be uneven causing the container to fall over. Even with a level surface the bucket can be kicked over by the painter focusing on the area he is painting and not where he is stepping. Another option is to carry the bucket for the time it takes to complete the area. Long periods of carrying a bucket with paint can result in muscle fatigue, cramps and lost productive time

Prior art is replete with examples of holders for knives, handguns, other specific tools or containers which partially address but do not solve these problems. Some are designed for belt use or hung over ones shoulder or around ones neck, others to be mounted on various surfaces. Some examples follow, however, none were found which could be both belt mounted and be attached to an extended ladder in a manner as to hold the container in an upright position.

U.S. Pat. No. 2,242,833, May 20, 1941, Nibur shows a container holder which is designed to be mounted on a table.

U.S. Pat. No. 2,698,155, Dec. 28, 1954, Bowman, shows a suction cup mounted beverage holder or receptacle for use in motor vehicles or other smooth surface.

U.S. Pat. No. 2,903,225, Sep. 8, 1959, Weinstein shows a wall or structure mounted holder for drink containers.

U.S. Pat. No. 3,997,092, December 1976, Pogwizd provides a paint container carrier, supported by straps around the neck and torso.

U.S. Pat. No. D280,258, Aug. 27, 1985, Miller describes a belt mounted holder for a propane tank and torch.

U.S. Pat. No. 5,009,348, Apr. 23, 1991, Describes a knife sheath in the form of a snap closed pouch attached to a mounting surface which has offset belt slots in order to orient the knife to a forward facing angle.

U.S. Pat. No. D433,229, Nov. 7, 2000, Harker shows a design for a belt mounted tool holder.

U.S. Pat. No. 6,227,510, May 8, 2001, McMullen describes a holder for containers which is attachable to a portable chair or other tubular uprights.

U.S. Pat. No. 5,783,538, Jul. 22, 2014, Dattilo, provides a belt worn holder for a specific paint pail which allows the pail to be held in the holder or by hand. This holder solves some problems but leaves a large empty holder protruding from the users waist belt when the pail is used in the hand.

The said “Paint Can-dle” mentioned was successfully used in a commercially available utility knife holder, AWP #0050108 made in Mexico for “The Rooster Group of San Antonio, Tex.”. This holder is for belt mount only.

### SUMMARY OF THE INVENTION

A primary object of the invention is to provide a toll holder which is simple in construction, well-adapted for Injection Molding and mass production techniques, low in cost, and reliable in use that provides for near plumb, tilt-resistant, positioning of a tool on extended ladder members having wide-ranging angles of inclination and that may remain attached during folding or carrying of a ladder or detached to be carried by a users waist belt.

Therefore it is an object of the present invention to provide a device for holding a tool or handled container and facilitate the safe, two handed, operation of a ladder when worn on a worker's belt, positioned on users front left side to front right side, or when attached to an extended ladder.

Another object of this invention is to provide a tool support means which can be easily connected and disconnected from user or support structure, or may be fixedly attached directly to a support member.

Yet another object of this invention is to provide a holding device which accepts container handles or tools which can be easily inserted and removed and which permits selective and adjustable positioning of the tool holder in relation to the structure to which it is attached.

It is still another object of this invention to provide a carrier that makes a painter's job safer by providing a hands free device which helps the user avoid muscle tension and fatigue with less back bending while providing easy access to needed material. The tool holder to be made of non-conductive molded plastic, reducing the danger of electrical shock and enabling manufacture in a variety of high visibility safety colors.

Accordingly, a principal object of this invention is to provide a tool holder which improves painting efficiency and safely:

In these respects, the present invention substantially departs from the conventional concepts and designs of the prior art, and in so doing provides an apparatus primarily developed for the purpose of providing an adjustable position device for holding a tool to a support structure.

Other objectives and advantages of this invention will become apparent and obvious from a study of the included description and accompanying drawings which are merely illustrative of the current invention and should not be constructed as limiting the scope of said invention. The preferred embodiment as described is only one of a variety of shapes and slot locations. Accordingly, departures may be made from such details without departing from the spirit and scope of this invention's concept.

### DETAILED DESCRIPTION OF INVENTION DRAWINGS

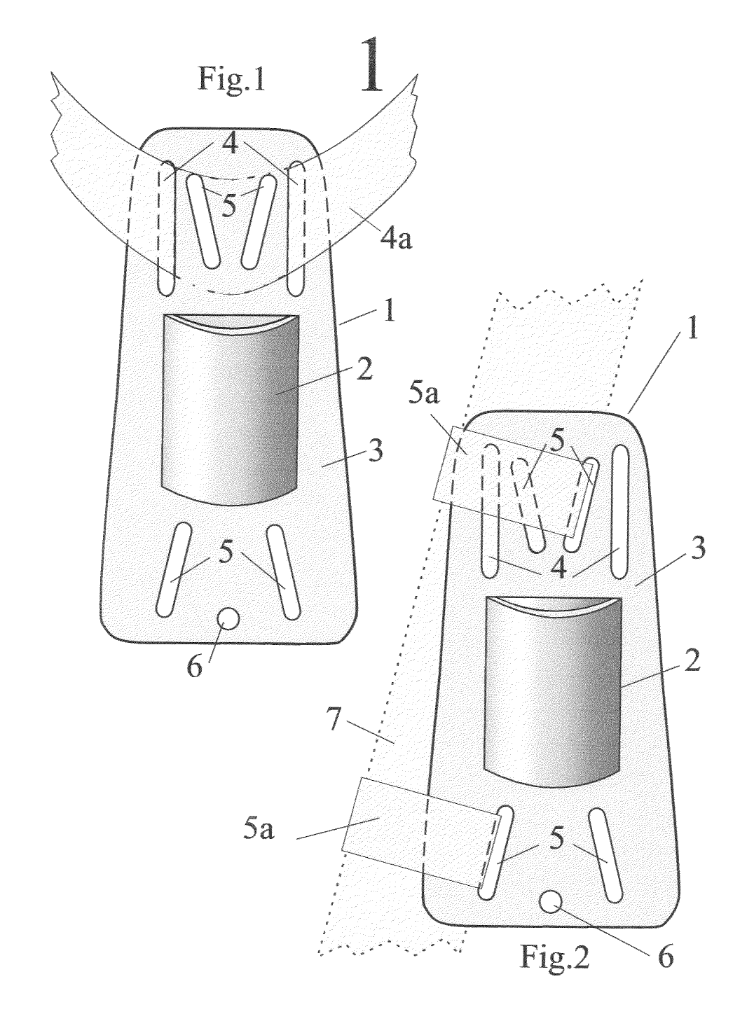

The present invention relates to an improved tool holder 1 as illustrated in FIG. 1 which is molded of a pliable plastic material to form a flat, trapezoid, oblong, oval, or rectangular mounting surface 3 with multiple elongated receiving slots 4&5 for accepting a belt 4a or straps 5a, a hanger hole 6 and a tool holding collar 2 protruding outward from said mounting surface 3 in a semi-circular shape of sufficient diameter and length to accept and allow the handle of said tool or container to be held parallel to the tool holder. When said handled container is handheld, the tool holder 1 might be used to hold a paint brush, screwdriver, pliers or other tool as fits into the tool holding collar 2. The tool holder material is of sufficient strength to enable the support of a quart of paint or said tools as may fit the tool holding collar.

In use, the top parallel belt receiving slots 4 are used to accept a waist belt 4a, or top and other receiving slots 5 are selected which will hold the holster in the most useful position when used on an angled ladder rail, FIG. 2. The flexible straps 5a are attached through the selected top and other slots 4 & 5 and around the ladder leg or stile 7. For safety, select a strap position above the highest useful rung to prevent said holder from sliding downward.

### DRAWING REFERENCE NUMERALS

1 “P C Holster/Tool Holder”
2 tool holding collar
3 mounting surface
4 parallel belt receiving slots
4a user's waist belt
5 angled strap receiving slots
5a flexible strap
6 hanger hole (aperture)
7 Ladder leg or stile

### BRIEF DESCRIPTION OF DRAWING FIGURES

FIG. 1 shows the invention 1, as used on a workmens belt 4a and using parallel receiving slots 4.

FIG. 2 shows the invention 1, as attached to an angled ladder stile 7, utilizing straps 5a through selected angled strap receiving slots 5.

1) A tool holding device, comprising a minting surface section and a tool holder collar section, for suspension from or attachment to stepladders, extension ladders, scaffolding and the like, whereby the tool holder mounts to support members such as side rails on either side of said ladders by means of flexible straps passed through angled strap receiving slots provided in said mounting surface and secured about said support members in a manner that provides for secure plumb positioning of a tool or container and which deters tilling and toppling of said tool or container.

2) The holding device of claim (1) whereby said device may be suspended front a user's waist belt at selected locations as may provide ambidextrous access and usage of tools by utilizing parallel belt slots provided.

3) The receiving slots of claim (1) which are positioned whereby the tool holder is adapted for mounting to support members at any angle from horizontal to vertical within a vertical plane and in such position that provides for secure, near plumb, positioning of a tool or container and which deters tilting and toppling of said tool or container from said position.

4) The flexible straps of claim (1) where said straps are made of Velcro® like hook and loop material, a material having a buckle type closure or the like, being of sufficient strength to support a minimum 20# (twenty pound) tool.
